(19) United States
(12) Patent Application Publication
(10) Pub. No.: US 2005/0118972 A1
(43) Pub. Date: Jun. 2, 2005

(54) RF circuit for disc playing apparatus

(75) Inventors: Masaaki Nara, Ora-Gun (JP); Masashi Arai, Ora-Gun (JP); Michihiro Kuraoka, Ora-Gun (JP)

Correspondence Address: OSHA & MAY L.L.P., 1221 MCKINNEY STREET, SUITE 2800, HOUSTON, TX, 77010, US

(73) Assignee: Sanyo Electric Co., Ltd., Osaka (JP)

(21) Appl. No.: 10/997,207

(22) Filed: Nov. 24, 2004

(30) Foreign Application Priority Data
Dec. 1, 2003 (JP) 2003-402183

(51) Int. Cl. H04B 1/04; H04B 17/00; H04B 1/06; H04B 7/00

(52) U.S. Cl. 455/234.1; 330/278

(57) ABSTRACT

When a state in which the amplitude level of an RF signal is equal to or lower than a predetermined level is detected by a DEF signal generation unit 36 (RF signal level detection unit), an auto-gain control unit (AGC) 34 suppresses the amplification factor thereof to be lower than the amplification factor when the state is not detected. Thereby, the increase and the variation of the RF signal at the time of returning from a level lowering caused by a scratch or the like are suppressed.

### CROSS-REFERENCE TO RELATED APPLICATIONS

The disclosure of Japanese Patent Application No. 2003-402183 including specification, claims, drawings, and abstract is incorporated herein by reference in its entirety.

### BACKGROUND OF THE INVENTION

1. Field of the Invention

The present invention relates to an RF circuit for processing a radio frequency (RF) signal in a disc playing apparatus.

2. Description of the Related Art

A disc playing apparatus (a device for reproducing a signal recorded on a removable media such as an optical disk), e.g., a compact disc playing apparatus, generates a final output signal through an RF amplifier (RF circuit) for amplifying an RF signal obtained by an optical pickup, a digital signal processing unit (DSP) for performing processing of an output signal of the RF amplifier such as clock generation, synchronous detection, demodulation, error detection and error correction, a D/A converter (DAC) for converting an output signal of the DSP to an analog signal, and the like.

An auto-gain control amplifying unit (AGC) for equalizing, to the extent possible, the amplitude levels of RF signals is provided to the RF amplifier. Then, the RF signals output from the AGC are input into the DSP.

Moreover, the RF amplifier is provided with a tacking error output signal generating unit (TE signal generating unit) for generating a tracking error output signal (TE signal), and a focus error output signal generating unit (FE signal generating unit) for generating a focus error output signal (FE signal). The TE signal is amplified in order to follow the level of the RF signal output from the AGC of the RF amplifier based on the level of the RF signal. The TE signal is used for tracking correction and the like. Moreover, the FE signal is similarly amplified in order to follow the level of the RF signal output from the AGC of the RF amplifier based on the level of the RF signal. The FE signal is used for focus correction and the like. One example of a known AGC is that disclosed in Japanese Utility Model Laid-Open Publication No. Hei 5-25845.

When such a disc includes a scratch is read using a conventional compact disc playing apparatus, the amplitude level of an RF signal is lowered during the period corresponding to the reading of the data stored near the scratch position. FIG. 4 is a view showing an example of the reduction of the amplitude level. In FIG. 4, the upper step shows a waveform of an RF signal after being output from the AGC, and the lower step shows a waveform of a TE signal. The abscissa axis indicates time, and the ordinate axis indicates the level of each signal. Td is a period corresponding to the scratch.

Here, because the AGC tries to maintain the RF signal at a predetermined level, the gain thereof becomes maximum at a state corresponding to the scratch, in which the level is lowered. Consequently, when the level of the RF signal begins to return to the normal level, the level of the RF signal and the variation of the level become large (indicated by an arrow A in FIG. 4). As a result, there is a problem in which the reproduction of signals cannot be performed normally.

Moreover, as described above, because the apparatus is configured such that the TE signal is amplified according to the level of the RF signal output from the AGC, the level of the TE signal varies when the level of the RF signal varies, at the end of each period in which the level of the RF signal is being lowered (indicated by an arrow B in FIG. 4). As a result, there is a problem that tracking correction and the like are often hampered. Although the waveforms are not illustrated, similar level variations are generated in the FE signal.

### SUMMARY OF THE INVENTION

An RF circuit for a disc playing apparatus according to the present invention includes an auto-gain control amplifier unit for adjusting an amplitude level of an RF signal from a pickup, and an RF signal level detection unit for detecting that the amplitude level of the RF signal amplified by the auto-gain control amplifier unit is equal to or lower than a predetermined level, wherein the auto-gain control amplifier unit suppresses an amplification factor of the amplifier unit when a state in which the level of the RF signal is equal to or lower than the predetermined level is detected by the RF signal level detection unit to be lower than the amplification factor when the state is not detected.

Moreover, it is preferable that, in the RF circuit for the disc playing apparatus, the auto-gain control amplifier unit substantially stops the amplification of the RF signal when the RF signal level detection unit detects the level of the RF signal to be equal to or lower than the predetermined level.

Moreover, it is preferable that the RF circuit for the disc playing apparatus further includes a current supply unit for supplying a current for stopping the amplification of the RF signal substantially to said auto-gain control amplifier unit based on the output signal from the RF signal level detection unit.

Moreover, it is preferable that, in the RF circuit for the disc playing apparatus, the RF signal level detection unit is used as a scratch detection unit for detecting a scratch on a disc.

Moreover, an integrated circuit for a disc playing apparatus according to the present invention includes the above-mentioned RF circuit, and a servo control unit for performing servo control of a predetermined movable mechanism based on an output from the RF circuit.

### BRIEF DESCRIPTION OF THE DRAWINGS

FIG. 1 is a diagram showing an example configuration of the main components of a compact disc playing apparatus according to an embodiment of the present invention;

FIG. 2 is a diagram showing an example configuration of the main components of an RF amplifier (RF circuit) included in the compact disc playing apparatus according to the embodiment of the present invention;

FIGS. 3A and 3B are diagrams showing waveforms of example RF, DEF, and TE signals output by the RF amplifier (RF circuit) according to the embodiment of the present invention; and

FIG. 4 is a diagram showing the wavelengths of an RF signal and a TE signal output from an RF amplifier in a conventional compact disc playing apparatus.

### DESCRIPTION OF PREFERRED EMBODIMENT

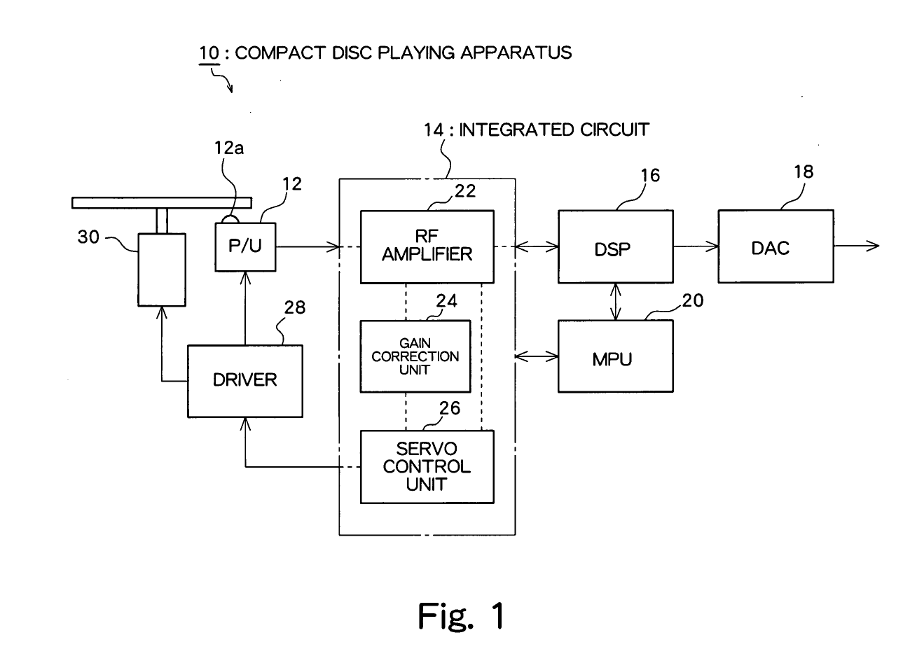

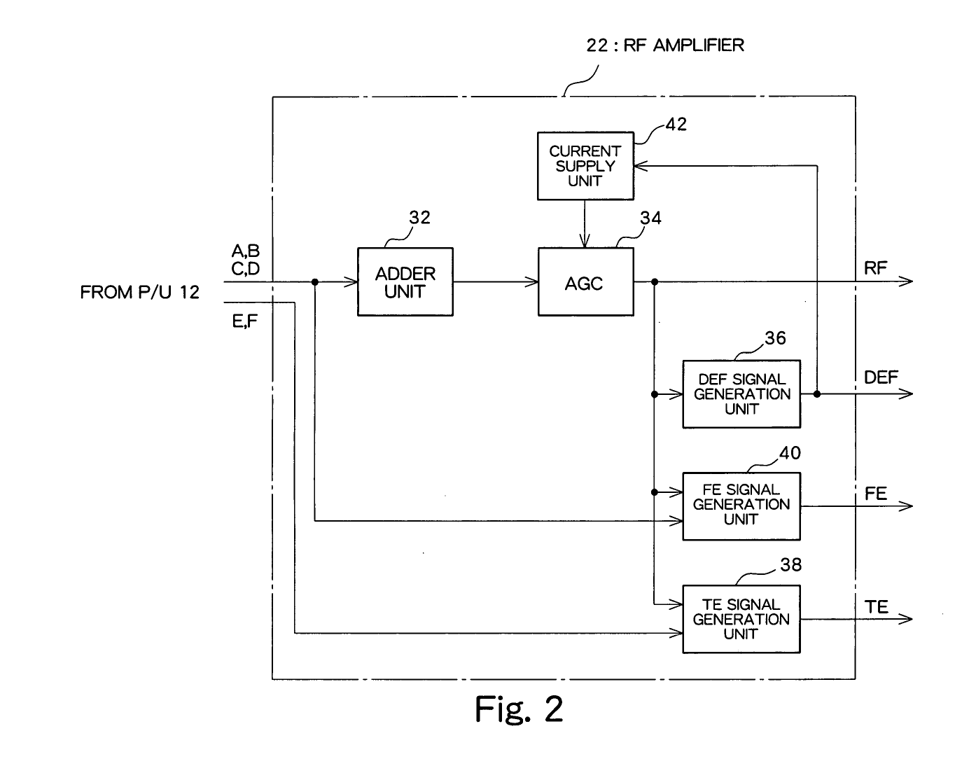

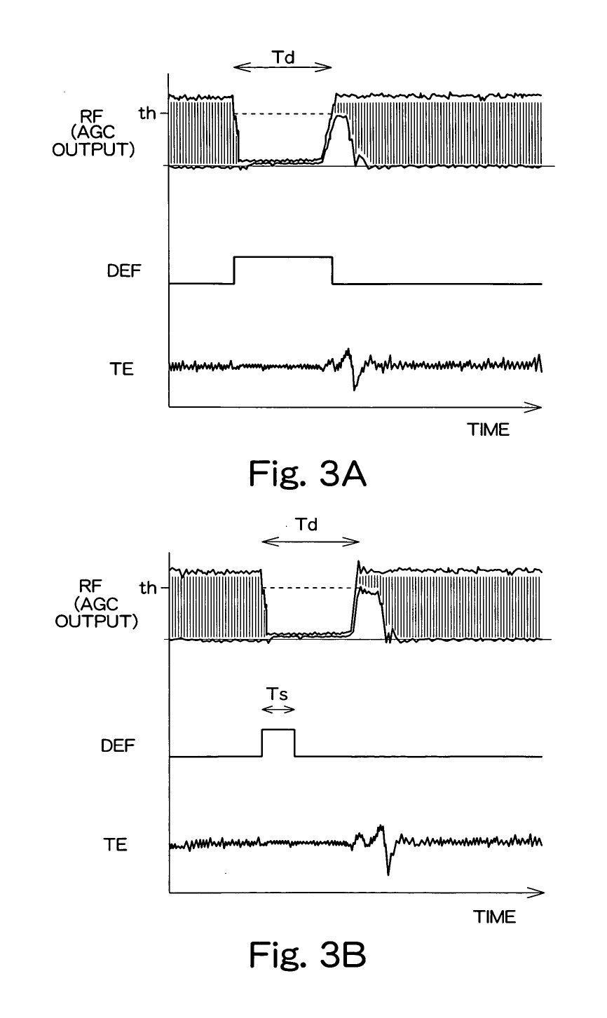

A preferred embodiment of the present invention will be described referring to the attached drawings. FIG. 1 is a diagram showing an example configuration of the principal components of a compact disc playing apparatus 10 according to the present embodiment. FIG. 2 is a diagram showing an example configuration of the principal components of an RF amplifier 22 included in the compact disc playing apparatus 10. FIGS. 3A and 3B are diagrams showing example waveforms of signals (RF, DEF, and TE signals) generated by the RF amplifier 22. In FIG. 3, the upper step shows RF, the middle step shows DEF, and the lower step shows TE, the abscissa axes indicate time, and the ordinate axes indicate the level of each signal.

The compact disc playing apparatus 10 of FIG. 1 includes a pickup 12, an integrated circuit 14, a digital signal processor (DSP) 16, a digital-to-analog converter (DAC) 18, a micro processor unit (MPU) 20, a driver 28, and a spindle motor 30.

The pickup 12 includes an optical detection mechanism for detecting a signal recorded on a compact disc optically, and outputs main signals (A, B, C, and D) and auxiliary signals (E and F).

The integrated circuit 14 includes the RF amplifier 22, a gain correction unit 24, a servo control unit 26, and the like.

Among these components, the RF amplifier 22 performs the processing of an RF signal output from the pickup 12 such as addition, filtering, amplification, and the like. The details of the configuration and the processing of the RF amplifier 22 are described below.

The gain correction unit 24 generates a correction signal for performing gain correction based on a defect (DEF) signal (described below) output from the RF amplifier 22. A tracking driver and a focus driver (both not shown) move the objective lens 12a of the pickup 12 based on the correction signal and a control signal from the servo control unit 26, to thereby correct tracking and focus errors.

The servo control unit 26 includes a focus servo control unit, a tracking servo control unit, a pickup feed servo control unit, a spindle servo control unit (all not shown), and the like. Each driver provided in the driver 28 (such as the focus driver, the tracking driver, a feed motor driver, and a spindle motor driver, all not shown) drives a corresponding moving mechanism (such as the pickup 12, the spindle motor 30, and a feed motor, not shown) in response to a control signal from a corresponding control unit in the servo control unit 26.

The DSP 16 performs processing, such as clock generation, synchronization detection, demodulation, and error detection, of a signal output from the RF amplifier 22. Then, an output of the DSP 16 is input into the DAC 18 to be converted to an analog signal by the DAC 18. Moreover, the MPU 20 functions as a system control unit for controlling each unit of the integrated circuit 14 and the DSP 16.

The RF amplifier 22 of FIG. 2 includes an adder unit 32, an auto-gain control unit (AGC) 34, a DEF signal generation unit 36, a TE signal generation unit 38, an FE signal generation unit 40 and a current supply unit 42.

In the RF amplifier 22, first the adder unit 32 adds the main signals (A, B, C, and D), and the combined signal is input into the AGC 34.

The gain of the AGC 34 is automatically adjusted in order to adjust the amplitude level of the input RF signal to nearly a predetermined fixed level. In a concrete example, the AGC 34 includes a comparator (not shown) therein, and compares the amplitude level of the RF signal with a predetermined reference level using the comparator. The above-mentioned gain adjustment can be realized by designing the operation of the AGC 34 as follows. First, when the extent to which the amplitude level of the RF signal exceeds the reference level grows, the AGC 34 will reduce the gain, while, when the amplitude level of the RF signal falls further below the reference level, the AGC 34 will increase the gain. Accordingly, the AGC 34 can be configured in order that, for example, the base potential of a specific transistor (not shown) may vary according to the difference of the levels (voltages) for increasing the amplifying gain of the RF signal, as the current between the emitter and the collector (current between E and C) of the transistor increases.

The DEF signal generation unit 36 generates a defect signal (DEF) based on the RF signal output from the AGC 34. The DEF signal generated by the DEF signal generation unit 36 is input into the DSP 16 and the Gain correction unit 24. The DEF signal generation unit 36 is also used as a scratch detection unit for detecting a scratch present on a disc.

The DEF signal generation unit 36, as shown in FIGS. 3A and 3B, generates a signal which becomes high (H) level when the peak level of the RF signal assumes a value less than or equal to a predetermined threshold value th. FIG. 3A shows an example wherein the DEF signal generation unit 36 is configured to output the DEF at the H level over almost the entire period in which the peak level of the RF signal assumes a value less than or equal to the threshold value th. FIG. 3B shows an example wherein the DEF signal generation unit 36 is configured to output the DEF at the H level for a period shorter than the period when the peak level of the RF signal is taking values equal to or less than the threshold value th. It should be noted that, in the example of FIG. 3B, the DEF become the H level for a fixed period Ts after the point at which the peak level of the RF signal matches or falls below the threshold level th, regardless of the length of the period Td during which the RF signal is falling.

The TE signal generation unit 38 generates a tracking error signal (TE) based on the auxiliary signals (E, F), for example, as a difference between the auxiliary signals (E−F). Moreover, the TE signal generation unit 38 amplifies the TE in accordance with the amplitude level of the RF signal output from the AGC 34. Consequently, the amplitude level of the TE is associated with the amplitude level of the RF signal output from the AGC 34.

Moreover, the FE signal generation unit 40 generates a focus error signal (FE) as a difference of groups of the main signals (A+C)−(B+D) output from the pickup 12. Meanwhile, the FE signal generation unit 40 amplifies the FE in accordance with the amplitude level of the RF signal output from the AGC 34. The FE and the TE are input into the servo control unit 26 to be used for servo control of each unit.

Then, the RF amplifier 22 of the present embodiment is provided with a mechanism for lowering the gain of the AGC 34 when the level of the RF signal falls below the predetermined threshold level. This mechanism suppresses the increase of the gain of the AGC 34 when the level of the RF signal returns from a sate of being lowered, and thereby also suppresses increase or variation of the level of the RF signal.

The RF amplifier 22 in FIG. 2 utilizes the DEF for this mechanism. As described above, the DEF shows that the RF signal output from the AGC 34 is equal to or less than the predetermined threshold value th. That is, by making the gain of the AGC 34 when the DEF is at the H level lower than that when the DEF is not at the H level (at the L level), the above-described mechanism can be realized. It is also possible to provide a circuit for detecting a peak level or an average level of the RF signal to utilize the output of the circuit. In such a case, a waveform suitable for the control of the AGC 34 (the pulse width of the H level) can be made to be compatible with a waveform of the DEF signal suitable for the tracking control and other controls.

Then, as the mechanism for suppressing the gain of the AGC 34, the current supply unit 42 is provided in the RF amplifier of FIG. 2. The current supply unit 42 includes, for example, a constant current circuit. When the DEF signal (or a signal indicating a falling of the RF signal) is at the H level, the current supply unit 42 supplies a predetermined current to a fixed point in the circuit of the AGC circuit 34 for suppressing the gain of the AGC 42 to be small. As an example, as described above, when the AGC 34 is configured such that the base potential of a specific transistor may vary according to the level difference between the amplitude level of an RF signal and the predetermined reference level, and the amplification gain of the RF signal may increase when a current between the base and the emitter of the specific transistor increases, the predetermined current may be supplied from the current supply unit 42 in order that the current between the emitter and the collector may decrease. When the transistor is of a PNP type, the current between the emitter and the collector decreases to make the gain of the AGC 34 smaller when the base potential increases. Accordingly, the base potential may be increased by supplying a current (of positive polarity) from the current supply unit 42 to the base of the specific transistor. In such a case, it is preferable to set the value of the current so as to ensure that the AGC 34 will not amplify the RF signal substantially while current is being supplied from the current supply unit 42.

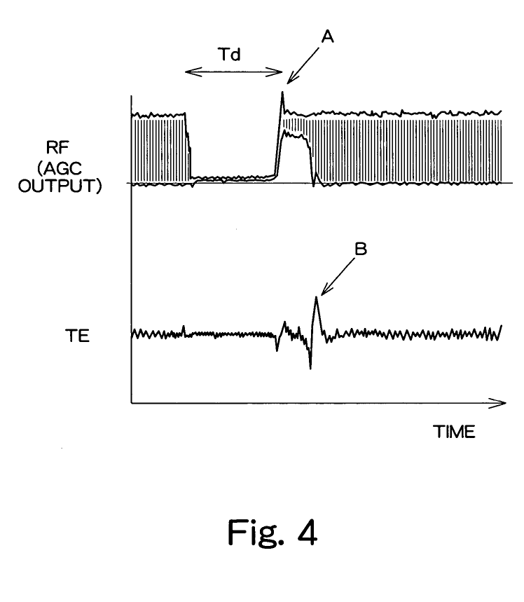

FIGS. 3A and 3B show waveforms of signals produced by a compact disc playing apparatus configured such that the function of the amplification of the AGC 34 is substantially stopped during the period in which the DEF takes the H level. Incidentally, FIGS. 3A, 3B, and 4 show signal waveforms all of which are obtained under the same condition (to the scratch on the reading surface of a disc). That is to say, when the graphs of FIGS. 3A and 3B are compared with the graphs of FIG. 4, the effect of the suppression of the gain of the AGC 34 becomes clear.

First, as described above, FIG. 3A shows waveforms when the amplification function of the AGC 34 is substantially stopped when the H level is output as the DEF over almost the entire period Td in which the amplitude level (peak level) of the RF signal is less than or equal to the predetermined value th. When FIG. 3A is compared with FIG. 4, it can be seen that the large variation A of the RF signal as shown in FIG. 4 is not present in FIG. 3A, and that the level variation B generated in the TE of FIG. 4 is small in FIG. 3A.

Moreover, FIG. 3B shows waveforms when the amplification function of the AGC 34 is substantially stopped only during the predetermined period Ts, shorter than the period Td in which the amplitude level (peak level) of the RF signal is equal to or lower than the predetermined value th. Also, when FIG. 3B is compared with FIG. 4, it can be seen that the variations in both the RF and the TE are smaller comparison with those shown in FIG. 4. In FIG. 3B, the AGC 34 is off only during the period Ts, which is shorter than the period Td. However, once the AGC 34 is turned off, some time is required before a normal state (the state in which the gain thereof varies according to the amplitude of the RF) is resumed. Consequently, the gain of the AGC 34 does not increase immediately after the end of the period Ts. Therefore, the above-described effect can be obtained. When FIGS. 3A and 3B are compared, it can be seen that the effect is larger in the example illustrated in FIG. 3A.

As described above, according to the present invention, increase and variation in the levels of the RF signal and the TE can be suppressed by suppressing the gain of the AGC when the amplitude level of the RF signal decreases, such that sound “skips” and the like caused by the increase and the variation of the levels can be suppressed. Although the showing and the detailed description are omitted, as to FE, the increase and the variation of the level thereof can be suppressed similarly to the case of the TE. It should be noted that the present invention is not limited to the example used to illustrated the preferred embodiment. For examples, variations by means of equivalent circuits and the like can be embodied, and the present invention may be applied to the playback of optical discs other than the compact discs.

1. An RF circuit for a disc playing apparatus, said RF circuit comprising:
an auto-gain control amplifier unit for adjusting an amplitude level of an RF signal received from a pickup; and
an RF signal level detection unit for detecting whether the amplitude level of the RF signal amplified by said auto-gain control amplifier unit is equal to or lower than a predetermined level,
wherein said auto-gain control amplifier unit suppresses an amplification factor of said amplifier unit when a state in which the level of the RF signal is equal to or lower than the predetermined level is detected by said RF signal level detection unit, to an amplification factor lower than the amplification factor when said state is not detected.

2. The RF circuit according to claim 1, wherein said auto-gain control amplifier unit substantially stops the amplification of the RF signal when a state in which the level of the RF signal is equal to or lower than the predetermined level is detected by said RF signal level detection unit.

3. The RF circuit according to claim 2, further comprising a current supply unit for supplying a current for stopping the amplification of the RF signal substantially to said auto-gain control amplifier unit in response to a signal output from said RF signal level detection unit.

4. The RF circuit according to claim 1, wherein said RF signal level detection unit is used as a scratch detection unit for detecting a scratch on a disc.

5. The RF circuit according to claim 2, wherein said RF signal level detection unit is used as a scratch detection unit for detecting a scratch on a disc.

6. The RF circuit according to claim 3, wherein said RF signal level detection unit is used as a scratch detection unit for detecting a scratch on a disc.

7. An integrated circuit for a disc playing apparatus, comprising:
an RF circuit according to claim 1; and
a servo control unit for performing servo control of a predetermined movable mechanism in response to an output from said RF circuit.

8. An integrated circuit for a disc playing apparatus, comprising:
an RF circuit according to claim 2; and
a servo control unit for performing servo control of a predetermined movable mechanism in response to an output from said RF circuit.

9. An integrated circuit for a disc playing apparatus, comprising:
an RF circuit according to claim 3; and
a servo control unit for performing servo control of a predetermined movable mechanism in response to an output from said RF circuit.

10. An integrated circuit for a disc playing apparatus, comprising:
an RF circuit according to claim 4; and
a servo control unit for performing servo control of a predetermined movable mechanism in response to an output from said RF circuit.

11. An integrated circuit for a disc playing apparatus, comprising:
an RF circuit according to claim 5; and
a servo control unit for performing servo control of a predetermined movable mechanism in response to an output from said RF circuit.

12. An integrated circuit for a disc playing apparatus, comprising:
an RF circuit according to claim 6; and
a servo control unit for performing servo control of a predetermined movable mechanism in response to an output from said RF circuit.

13. An RF circuit for a compact disc playing apparatus, said RF circuit comprising:
an auto-gain control amplifier unit for adjusting an amplitude level of an RF signal received from a pickup; and
an RF signal level detection unit for detecting whether the amplitude level of the RF signal amplified by said auto-gain control amplifier unit is equal to or lower than a predetermined level,
wherein said auto-gain control amplifier unit suppresses an amplification factor of said amplifier unit when a state in which the level of the RF signal is equal to or lower than the predetermined level is detected by said RF signal level detection unit, to an amplification factor lower than the amplification factor when said state is not detected.

14. The RF circuit according to claim 13, wherein said auto-gain control amplifier unit substantially stops the amplification of the RF signal when a state in which the level of the RF signal is equal to or lower than the predetermined level is detected by said RF signal level detection unit.

15. The RF circuit according to claim 14, further comprising a current supply unit for supplying a current for stopping the amplification of the RF signal substantially to said auto-gain control amplifier unit in response to a signal output from said RF signal level detection unit.

16. The RF circuit according to claim 15, wherein said RF signal level detection unit is used as a scratch detection unit for detecting a scratch on a compact disc.

17. An integrated circuit for a compact disc playing apparatus, comprising:
an RF circuit according to claim 13; and
a servo control unit for performing servo control of a predetermined movable mechanism in response to an output from said RF circuit.

18. An integrated circuit for a compact disc playing apparatus, comprising:
an RF circuit according to claim 14; and
a servo control unit for performing servo control of a predetermined movable mechanism in response to an output from said RF circuit.

19. An integrated circuit for a compact disc playing apparatus, comprising:
an RF circuit according to claim 15; and
a servo control unit for performing servo control of a predetermined movable mechanism in response to an output from said RF circuit.

20. An integrated circuit for a compact disc playing apparatus, comprising:
an RF circuit according to claim 16; and
a servo control unit for performing servo control of a predetermined movable mechanism in response to an output from said RF circuit.
